(19) United States
(12) Patent Application Publication
(10) Pub. No.: US 2018/0010362 A1
(43) Pub. Date: Jan. 11, 2018

(54) Door Furniture And Method of Installation

(71) Applicant: Ace Products Holdings Pty Ltd, Darra (AU)

(72) Inventors: Anaru Terei, Darra (AU); Edward T. Laverty, Darra (AU); Colin Horton, Darra (AU)

(21) Appl. No.: 15/644,221

(22) Filed: Jul. 7, 2017

(30) Foreign Application Priority Data
Jul. 7, 2016 (AU) 2016204726

(51) Int. Cl. E05B 9/08; E05B 3/04; E05B 7/00; E05B 17/06; E05B 79/06; E05C 1/08

(52) U.S. Cl. CPC E05B 9/08; E05B 17/06; E05B 79/06; E05B 3/04; E05B 7/00; E05C 1/08

(57) ABSTRACT

The present invention relates to door furniture and methods of installation and particularly to door furniture for interior doors to minimize assembly issues.

### TECHNICAL FIELD

The present invention relates to door furniture and methods of installation and particularly to door furniture with components to minimise assembly issues.

### BACKGROUND ART

Door furniture (levers and escutcheon sets as commonly used on interior doors) is known for being awkward and time-consuming to install. Often parts have to be cut to length (fixing screws, spindles and the like). In addition to this, parts can fall out as they are installed (calling for the need for a “third hand”). Also, if the levers are provided in the wrong hand (suited to a left hand hung door as opposed to a right-hand hung door), it can be difficult and time-consuming for the average person to change handing.

In attempting to change handing, it is very easy to lose parts of the assembly, rendering the product useless. This can mean a second trip to the hardware store and more expense.

Even for an experienced locksmith, these issues can be a problem as it has an effect on job pricing and the time taken to complete the task. For a carpenter who may be fitting many sets of door furniture in a building, this can be a serious problem.

For a manufacturer or wholesaler, the wide number of lever styles available today, can mean carrying a significant inventory in order to be able to satisfy customer orders. To fill all possible orders, sets of both left and right handing have to be maintained and with each of the lever styles offered. This can mean carrying a lot of stock, some of which might be very slow moving, in order to be prepared for any possible order.

Yet another issue facing those who carry stock of and those who install door furniture is that conventional door furniture is either designed to be installed with a retractable latch or with a mortise lock. These two applications generally require different fixing screw orientations (horizontally opposed for a mortise lock and vertically opposed for a retractable latch). This is again, another burden on inventory as it this generally requires a separate (different) furniture set with currently available products.

It will be clearly understood that, if a prior art publication is referred to herein, this reference does not constitute an admission that the publication forms part of the common general knowledge in the art in Australia or in any other country.

### SUMMARY OF INVENTION

The present invention is directed to improved door furniture and method of installation, which may at least partially overcome at least one of the abovementioned disadvantages or provide the consumer with a useful or commercial choice.

With the foregoing in view, the present invention in one form, resides broadly in a door furniture assembly for a rotatable door handle or lever, the door furniture assembly including
a) a rotatable door handle or lever;
b) at least one furniture housing portion adapted to mount a rotatable door handle or lever relative thereto,
c) an operating cassette releasably engageable with the at least one furniture housing portion, the cassette including a spring housing, and a spring housing cover, together defining a housing to contain a lever spring and a drive plate to engage with the a rotatable door handle or lever; and
d) an elongate spindle to engage with the a rotatable door handle or lever and a retractable latch such that rotation of the door handle or lever causes movement of the retractable latch
wherein the rotatable door handle or lever can be reoriented relative to the operating cassette to change the handedness of the door furniture.

In an alternative aspect, the present invention resides in a hold-in spindle system for a rotatable door handle or lever mechanism, the system including
a) an elongate spindle,
b) at least one furniture housing portion mounting a handle or lever for rotation against a resilient return,
c) a spindle retaining member engageable with the spindle and having
   a. at least one deformable arm with a portion extending laterally beyond the spindle in order to releasably engage the spindle with the at least one furniture housing portion and
   b. at least one rigid engagement portion to engage with the spindle
      such that the elongate spindle and spindle retaining member can be snapfit to the at least one furniture housing portion to be held there by the spindle retaining member.

In an alternative aspect, the present invention resides in a snap fit mounting assembly for door furniture, the snap fit mounting assembly including
a) a first furniture housing portion to be mounted on a first side of the door,
b) a second furniture housing portion to be mounted on a second side of the door,
at least one of the first furniture housing portion and second furniture housing portion engageable with an opening mechanism and at least one of the first furniture housing portion and second housing portion having a seating groove at least partially about a circumferential surface thereof,
c) at least a pair of connectors associated with one of the first furniture housing portion and second furniture housing portion, each connector being length adjustable and each including at least one abutment shoulder and
d) at least one resilient clip seated in the seating groove and deformable to engage with the at least one abutment surface of each of the connectors when the first furniture housing portion and second furniture housing portion are forced together from opposite sides of the door in order to mount the housing portions to each other.

In normal operation of the present invention, the spindle engages with the rotatable door handle or lever and the drive plate also engages with the rotatable door handle or lever and the spring in the cassette. However, there is normally an indirect engagement between the drive plate and the spindle.

In some embodiments, the present invention includes at least one furniture housing portion adapted to mount a rotatable door handle or lever relative thereto. The rotatable door handle or lever is normally mounted relative to the door using an escutcheon or rose mounting the rotatable door handle. The escutcheon or rose typically has multiple components, in particular, will normally have at least one furniture housing portion in order to mount the rotatable door handle relative to the door and a detachable cover or trim which covers the furniture housing portion to provide an aesthetically pleasing view.

Any type of rotatable handle, lever or knob can be mounted relative to the escutcheon or rose including a passage lever or the like.

Typically the at least one furniture housing portion is circular but it may have any shape.

Generally, the at least one furniture housing portion is mounted relative to a door surface. Normally, the housing portion will define a cavity on one side thereof. The cavity may be any shape but is generally circular. A central bore is typically provided through the housing portion through which a portion of the door handle or lever is received.

The at least one furniture housing portion will preferably have an annular outer wall surrounding the preferred central bore with a peripheral wall extending from the outer wall to define the cavity on one side thereof. The cavity of the furniture housing portion will preferably receive operating components therein allowing the door handle portion extending through the preferred central bore, to engage with the operating components.

A number of mounting openings are provided, normally through the annular outer wall in order to receive fixing or mounting screws or similar to mount the housing portion relative to the door surface. Normally, four mounting openings are provided, two mounting openings allowing vertical screw fixing and two mounting openings allowing horizontal screw fixing. Normally, the user will select which of the mounting openings or combination of mounting openings is to be used to mount the furniture housing portion. Each leverset will normally be supplied as either horizontal or vertical fix mounting. Additional screws may be supplied to permit conversion if needed.

A fastener seating opening or depression is preferably provided on an interior side surface of the peripheral walls corresponding to the location of each of the mounting openings in the furniture housing portion in order to seat the fasteners used to mount the housing portion relative to the door surface at least partially therein. The openings or depressions are preferably arcuate and a semicircular shape is preferred. The mounting openings will preferably have a tapered entryway part provided about the end of each fastener seating opening or depression located on a free end of the peripheral wall. The tapered entryway part will typically correspond to a tapered entryway part provided on the preferred cassette to define a tapered entryway, discussed further below.

In relation to the fixing or mounting screws used to mount the housing portion relative to the door surface, it is preferred that at least some of the fixing or mounting screws are quick fix connectors as discussed below. Usually, either quick fix connectors or normal screws would be used, application dependent, although quick fix connectors can be used in combination with normal screws to secure the furniture housing portion to the door if desired by a user.

The peripheral wall of the at least one furniture housing portion is preferably provided with a seating groove into which a spring clip can be at least partially received. Preferably, the seating groove is or includes an opening provided into the preferred circular surface of the peripheral wall. Some portions of the seating groove may extend more deeply into or even, completely through the peripheral wall and therefore form elongate slot openings extending through the peripheral wall. The seating groove will typically seat the spring clip such that the spring clip extends, preferably laterally, partially into the fastener seating openings or depressions in the furniture housing portion. In this way, the spring clip can engage with portions of the fasteners used. As will be discussed below, the preferred spring clip is substantially C-shaped and therefore, the preferred seating groove will also be substantially C-shaped, provided relative to the preferred outer, circular surface of the peripheral wall.

It is also further preferred that an internal surface of the cavity, preferably an internal surface of the peripheral wall is provided with at least one cassette guide or alignment groove or protrusion in order to seat the cassette within the cavity and to prevent rotation of the cassette relative to the furniture housing portion once properly located in the cavity. It is particularly preferred that at least two cassette guide or alignment grooves or protrusions are provided with the corresponding configuration provided on the cassette. In a particularly preferred embodiment, a pair of arcuate open grooves is provided on one of the walls of the cavity of the furniture housing portion to correspond to a pair of arcuate protrusions provided on the cassette.

In use, typically a matched pair of housing portions is provided, one for either side surface of the door. The matched pair of housing portions are typically provided on either side surface of the door in alignment with one another and then connected together through the door, sandwiching the door between the connected housing portions.

The present invention also preferably includes an operating cassette releasably engageable with the at least one furniture housing portion, the cassette including a spring housing, a spring housing cover together defining a housing to contain a lever spring and a drive plate. According to the present invention, the elongate spindle engages with the lever/handle and the drive plate engages with the lever/handle and the spring. However, there is normally an indirect engagement between the drive plate and the spindle.

The cassette will preferably be provided in an assembled form in order to minimise the number of parts required to fit the door handle relative to the door. The spring housing and the spring housing cover will typically be attachable together in any way. It is preferred that the housing and cover will clip or snap together but fasteners may be used. The assembled cassette will also normally be provided within the furniture.

The spring housing will typically include an annular, substantially planar, outer wall and a peripheral wall extending therefrom in order to define a cavity within the spring housing. The spring housing will typically include a substantially centrally located opening in the annular outer wall in order to align with the preferred central opening in the furniture housing portion in order to receive and allow passage to part of the handle and/or spindle. The opening in the annular outer wall of the spring housing is preferably substantially circular.

According to a preferred embodiment, one or more portions of an operating mechanism will typically extend radially into the preferred central opening in the cassette in order to engage with a portion or portions of the handle and/or spindle.

It is preferred that the exterior of the peripheral wall of the spring housing is provided with at least one, and preferably a pair of cassette guide protrusions in order to seat the cassette within the cavity defined in the furniture housing portion. Normally, the protrusions are received in cassette guide grooves provided on an interior surface of the peripheral wall of the furniture housing portion. The protrusions are preferably arcuate portions, preferably extending over the height of the peripheral wall and in some circumstances, the protrusions may extend beyond a free end edge of the peripheral wall in order to guide attachment of the spring housing cover relative to the spring housing.

It is preferred that an external surface of the peripheral wall of the spring housing will also be provided with one or more depressions to allow passage of or to partially seat the mounting fasteners used to mount the furniture housing portion relative to the door. Again, the number of depressions will correspond to the number of fasteners used and typically four depressions are provided. It is preferred that the depressions are arcuate and preferably, the depressions extend over the height of the peripheral wall of the spring housing.

An internal side of the peripheral wall is preferably provided with one or more abutment shoulders in order to abut parts of the lever spring and/or a drive plate stop member provided on the drive plate. Typically, a C shaped portion is provided concentrically within the cavity of the spring housing, preferably against or as a part of the peripheral wall with an abutment shoulder provided at either end of the C shaped portion. Typically the abutment shoulder provided at one end of the C shaped portion will abut one end of the lever spring in order to brace the lever spring against movement and allow the drive plate to be rotated against the spring force of the lever spring and the abutment shoulder at the other end of the C shaped portion will preferably abut the drive plate stop member in the “home” position with the other side of the drive plate stop member abutting the other end of the lever spring in order to bias the drive plate into the “home” position. This mechanism will typically act to return the handle, lever or knob to the home position following use.

The lever spring of the preferred embodiment is helical. The lever spring is typically circular in shape with an abutment tab extending from either end of the lever spring in order to abut other components of the mechanism as described above.

The spring housing cover of a preferred embodiment preferably engages with the spring housing to form the cassette and contain rotating elements of the operating mechanism within. The spring housing cover will typically have an annular, substantially planar wall with a central opening and a number of peripheral side wall portions extending from the annular wall at an outer edge.

One or more snap arms provided with an abutment shoulder are provided on the spring housing cover in order to engage with an outer portion of the annular wall of the spring housing and/or peripheral wall of the spring housing in order to attach the spring housing cover to the spring housing to form the cassette. Generally, at least two snap arms are provided. It is preferred that the snap arms are slightly resilient in order to allow the snap arms to be forced over the peripheral wall of the spring housing during attachment. The snap arms typically deform about the connection point of the snap arm with the annular wall of the spring housing cover.

Preferably, a number of peripheral side wall portions of the spring housing cover are spaced apart in order to allow engagement of the spring housing cover with the spring housing. It is preferred that the spring housing cover is also provided with a number of arcuate opening portions to allow passage or seating of the mounting fasteners relative to the spring housing cover and the cassette when assembled. Again, the arcuate opening portions will typically have a tapering entry way part in order to define a tapered entry way when the cassette is located relative to the furniture housing portion. In use, the tapered entry way of the assembled cassette and furniture housing portion will function to guide a portion of the mounting fasteners and/or quick fix connectors to attach corresponding furniture housing portions to one another on either side of the door.

An internal surface of the spring housing cover may include one or more abutment shoulders in order to abut one or more shoulders provided on the drive plate.

The drive plate of some preferred embodiments is preferably circular and generally planar. The drive plate will typically have a substantially central opening. A drive plate stop member will typically extend substantially perpendicular from the drive plate.

An abutment arc portion may be provided on an opposite side of the drive plate to the drive plate stop member. The abutment arc portion will typically have a pair of abutment shoulders, one at either end. Normally the abutment arc portion will stand proud of the drive plate surface. In a particularly preferred embodiment, the abutment arc portion will preferably extend further away from a circular guide ridge provided on the drive plate, surrounding the preferred central opening.

The drive plate of the preferred embodiment preferably fits within the spring housing. In a preferred embodiment, the drive plate, and typically the surface of the drive plate on the side having the drive plate stop member will rest and rotate on the preferred C shaped portion provided within the spring housing.

The central opening of the drive plate will preferably have at least one, and preferably an opposed pair of engagement tabs to engage with the lever/handle. Normally, the engagement tabs will extend from the periphery defining the central opening of the drive plate, into the central opening. Each of the engagement tabs is preferably generally rectangular and extends in the same plane as the drive plate. The engagement tabs will typically engage a portion of the handle or lever which extends into the cassette of the preferred embodiment, once assembled. The spindle is preferably formed so as to not engage with the tabs on the drive plate.

The annular wall of the spring housing and/or spring housing cover will preferably have at least one depression therein to receive a stop plate in order to hold the cassette into the cavity of the furniture housing portion. In preferred configurations, the stop plate is a generally planar plate. Although the stop plate can have any shape, it is preferred that the stop plate is rectangular. It is also preferred that the stop plate is received in the depression provided, to be flush with the surface of the spring housing or spring housing cover. The fastener is typically provided, engaging with a portion of the peripheral wall of the furniture housing portion in order to hold the stop plate to the furniture housing portion, clamping the cassette within the cavity of the furniture housing portion. In use, the stop plate is preferably loosened and the lever handle rotated relative to the cassette normally through 180° and re-engaged, then the stop plate is re-tightened. The cassette normally stays substantially in place, and due to the reversal of orientation of the lever handle relative to the cassette, the lever handle engages the internal components of the cassette in the opposite direction.

In some forms, the present invention includes a spindle. Preferably, the spindle is a hold-in spindle which can be snapfit relative to the operating components of the mechanism providing tactile and/or double feedback as to the engagement of the spindle with the operating components of the mechanism and which will prevent the spindle being accidentally disconnected from the assembly during assembly and disassembly.

The spindle is typically elongate and generally rectangular. A depression is provided in at least one, and preferably a pair of opposed side walls of the spindle in order to receive the engagement tabs provided on the drive plate with the depressions provided to clear the tabs so that they preferably do not engage the spindle.

The hold-in spindle of preferred embodiments will have a split or divided tail to be received at least partially within or through the cassette. The split or divided tail is preferably configured as a pair of spaced apart portions to receive a part of a spindle retaining member therebetween. A laterally extending opening will typically be provided in each of the spaced apart portions in order to receive a spindle mounting pin thereinto. Normally, the laterally extending openings are provided in or into sidewalls other than the sidewalls with the depressions provided. The laterally extending openings are preferably substantially U-shaped. The laterally extending openings will typically allow insertion and removal of the spindle mounting pins in order to assemble and remove the spindle retaining member from the spindle.

The spindle retaining member will typically have at least one rigid engagement portion, preferably at least one spindle mounting pin, to engage with the spindle. The spindle retaining member will typically have a body from which the at least one spindle mounting pin extends.

The retaining member will also have at least one deformable arm with a portion extending laterally beyond the spindle in order to engage the spindle with the engagement tabs on the drive plate. Typically, the spindle mounting pins and the at least one deformable arm will extend in different planes to one another and normally, the plane in which the spindle mounting pins extends is substantially perpendicular to the plane in which the at least one deformable arm extends.

Normally, there will be a pair of opposed deformable arms. Typically, the deformable arms extend from the body of the spindle retaining member, preferably angled outwardly, from near one end of the spindle towards the other end of the spindle. When the spindle retaining member is assembled with the spindle, the deformable arms are preferably positioned such that they can be deformed inwardly to sit within the depressions provided for the engagement tabs. The free end of each deformable arm will typically stand proud of the spindle surface unless deformed. The free ends of the deformable arms allow the engagement tabs to pass, through deformation of the deformable arms and then the resilience of the deformable arms will typically return them to stand proud of the spindle in order to engage with a side (and/or end) surface of the engagement tabs to hold the spindle to the drive plate. The deformable arms will typically diverge away from the body of the spindle retaining member.

Preferably, the configuration of the spindle and the spindle retaining member means that the spindle can be removed and replaced if needed. However, if sufficient force is applied to the spindle to remove the spindle from the drive plate, the deformable arms may collapse in order to allow removal of the spindle. Removal in this way will typically ruin the spindle retaining member requiring a new spindle retaining member to be used prior to attaching spindle with the assembly after removal this way. Preferably, a user will be able to remove and re-insert the spindle without ruining the spindle retaining member.

It is preferred that the spindle retaining member is manufactured from plastic In order to provide rigidity to the spindle mounting pins and also provide the deformable arms with resilience.

As mentioned above, the resilient clip or spring clip of preferred embodiments will normally be substantially C-shaped. The spring clip will normally be manufactured of metal. The spring clip will normally be provided with a pair of free ends and the free ends will normally converge toward one another to allow the spring clip to engage the furniture housing portion.

The spring clip of a preferred embodiment can have any shape such as rectangular but preferably will have a substantially circular cross-section. The preferred cross sectional shape will allow the spring clip to be forced into deformation in order to allow the preferred quick fix connectors to pass, through the provision of an angled or tapered surface on the quick fix connectors but once seated in the seating groove, and engaging the abutment shoulders provided on the quick fix connectors, the spring clip will typically prevent withdrawal of the quick fix connectors unless the spring clip is again deformed to allow the release of the quick fix connectors. The seating groove will typically allow the spring clip to be received below the level of the peripheral wall of the furniture housing portion.

One or more quick fix connectors are preferably provided according to the present invention in order to attach corresponding furniture housing portions relative to one another, on opposite sides of the door. Each quick fix connector will typically be elongate. Each quick fix connector will typically have at least two parts namely a fastener portion having an enlarged head and an external thread provided on a shank and a connector barrel portion including a barrel which is typically internally threaded in order to engage with the external thread provided on the shank of the fastener portion.

Normally, the enlarged head and/or connector barrel portion of the fastener portion will have an engagement configuration adapted to engage with a tool to allow the fastener to be rotated.

The connector barrel portion is preferably provided with at least one circumferential abutment shoulder, normally towards an outer end, opposite the opening to the barrel. In a particularly preferred embodiment, at least one circumferentially extending groove will be provided towards an outer end of the connector barrel portion defining a pair of spaced apart abutment shoulders against which the spring clip can abut. The outer end will normally be closed and the outer end may be tapered or angled in order to force deformation of the spring clip as the fasteners abut the spring clip.

The shank of the fastener portion is also preferably provided with at least one circumferential abutment shoulder, normally towards the head of the fastener portion but spaced therefrom. In a particularly preferred embodiment, at least one circumferentially extending groove will be provided towards the head of the fastener portion but spaced therefrom defining a pair of spaced apart abutment shoulders against which the spring clip′ can abut.

In use, the circumferentially extending grooves on the quick fix connectors will engage with a spring clip provided on each furniture housing portion to hold the quick fix connector relative thereto. In use, the quick fix connectors are set at an approximate length for use and the head of the quick fix connector is typically attached to one furniture housing portion using the spring clip. The free ends of the quick fix connectors can then be inserted into the mounting openings of a corresponding furniture housing portion on the opposite side of the door. Pushing the housing portions together from either side of the door, forces the outer end of the connector barrel to temporarily deform the spring clip allowing passage of the connector barrel and the spring clip will resiliently return to seat in the seating groove of the furniture housing portion and the circumferentially extending groove on the quick fix fastener, attaching the housing portions together either side of the door. The fastener portion and/or connector barrel portion can then be rotated to clamp the housing portions together on either side of the door.

In an alternative embodiment, the fastener portion of each quick fix connector may have an enlarged head and an external thread provided on a shank. In this alternative embodiment, the enlarged head may be shaped to engage with a correspondingly shaped depression provided about the mounting opening provided in the cassette and/or assembled furniture.

In this embodiment, the mounting opening may be provided as an arcuate opening in the cassette and/or assembled furniture and preferably a pair of substantially opposed openings will be provided, one for each of a preferred pair of quick fix connectors. The shaped depression is preferably provided about or partially about one end of the arcuate opening. The arcuate opening preferably engages the preferred enlarged head of the fastener portion of the quick fix connector in a bayonet fitting such that the enlarged head of the fastener portion of the quick fix connector can be inserted into one end of the arcuate opening which allows passage of the enlarged head and the quick fix connector can then be moved relative to the arcuate opening in the cassette and/or assembly furniture to hold the quick fix connector in the arcuate opening with the shaped enlarged head received at least partially in the correspondingly shaped depression provided about the mounting opening in the cassette and/or assembled furniture. The engagement of the correspondingly shaped enlarged head and depression also means that the quick fix connector can be tightened without rotation of the fastener portion of the quick fix connector.

The shank of the fastener portion is also preferably provided with at least one circumferential abutment shoulder, normally towards the head of the fastener portion but spaced therefrom in order to abut a side surface of the furniture assembly. Preferably, the at least one circumferential abutment shoulder is provided on an alignment member mounted for movement along the shank of the fastener portion.

The alignment member may be moveable in any way relative to the shank of the fastener portion including using a fraction fit which allows the alignment member to be slid along the shank of the fastener portion but preferably the alignment member will be provided as an alignment nut with an internally threaded bore and the shank of the fastener portion will be provided with an externally threaded portion such that the alignment nut can be wound along the shank of the fastener portion to abut one side of the cassette and/or assembly furniture to hold the enlarged head of the fastener portion in the correspondingly shaped depression to hold the quick fix connectors relative to the cassette and/or assembly furniture as well as to align the quick fix connectors substantially perpendicularly to the cassette and/or assembly furniture.

In this configuration, the connector barrel portion is preferably also provided with an enlarged head which can be used to engage a cassette and/or assembled furniture arrangement on an opposite side of the door to the cassette and/or assembled furniture arrangement to which the fastener portion of the quick fix connectors is mounted. The enlarged head of the connector barrel portion preferably engaged with a shaped depression provided about the mounting opening, preferably allowing rotation of the connector barrel portion whilst engaged.

The shaped depression may therefore have a substantially circular depression portion surrounded by a hex shaped depression portion allowing the enlarged head of each of the fastener portion or the connector barrel portion to be engaged, as required. This will preferably allow rotation of the connector barrel portion whilst engaged but prevent rotation of the fastener portion whilst engaged.

In use, the connector barrel portion on the quick fix connectors will engage with substantially circular depression portion provided on each furniture housing portion to hold the quick fix connector relative thereto. In use, the quick fix connectors are set at an approximate length for use typically attached to one furniture housing portion. The enlarged head of the fastener portion of the quick fix connectors can then be inserted into the mounting openings of a corresponding furniture housing portion on the opposite side of the door. Rotation of the housing portions on either side of the door will preferably move the enlarged head of the fastener portion into the preferably hex shaped depression portion, attaching the housing portions together either side of the door. The preferred alignment nut is then wound to abut the cassette and/or furniture assembly. The housing portions can then be assembled onto the door and attached to a matching housing portion. The connector barrel portion can then be rotated to tighten the connection in order to clamp the housing portions together on either side of the door.

It can be seen that the present invention therefore provides a mechanism with fewer, free parts and a simpler attachment mechanism in order to allow a do-it-yourself installation and/or more rapid installation by experienced installers with less complexity and less risk of parts being misplaced or lost during the installation and/or removal.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an exploded view of an interior door handle and operating mechanism according to an aspect of the present invention.

FIG. 2 is an exploded view of an operating cassette for an interior door handle according to an aspect of the present invention.

FIG. 3 is an isometric view of the operating cassette illustrated in FIG. 2 in the assembled condition.

FIG. 4 is an elevation view of assembled door furniture including the operating cassette illustrated in FIG. 3.

FIG. 5 is an exploded view of a spindle subassembly according to a preferred embodiment of the present invention.

FIG. 6 is an isometric view of the spindle subassembly illustrated in FIG. 5 in the assembled condition.

FIG. 7 is a detailed sectional view of the engagement between the spindle illustrated in FIG. 6 with the drive plate of the door furniture according to a preferred embodiment.

FIG. 8 is an even more detailed view of the portion illustrated in FIG. 7.

FIG. 9 is an isometric exploded view of a pair of handles with the door furniture according to a preferred embodiment prior to mounting to a door.

FIG. 10 is a sectional view of the configuration illustrated in FIG. 9 in the assembled condition.

FIG. 11 is a detailed view of the portion illustrated in FIG. 10.

FIG. 12 is an isometric view of a quick fix connector according to an aspect of the present invention.

FIG. 13A to 13C shows the steps in the process of changing handing according to a preferred embodiment of the present invention.

FIG. 14A is an isometric view (with detail) of a first part of a door furniture assembly according to an alternative preferred embodiment for attachment of quick fix connectors relative to the door furniture assembly.

FIG. 14B is an isometric view of the first part of a door furniture assembly illustrated in FIG. 14A, from the reverse side.

FIG. 15A is a side elevation view of a quick fix connector according to the alternative preferred embodiment illustrated in FIG. 14A.

FIG. 15B is a side elevation view of a quick fix connector illustrated in FIG. 15A from the reverse side.

FIG. 16 is a front elevation view of the first part of a door furniture assembly illustrated in FIG. 14B.

FIG. 17 is a sectional view of the first part of a door furniture assembly illustrated in FIG. 14A along line A-A.

### DESCRIPTION OF EMBODIMENTS

According to a particularly preferred embodiment of the present invention, a door furniture assembly for a rotatable door handle is provided.

The door furniture assembly illustrated in the Figures includes at least one furniture housing portion 10 adapted to mount a rotatable door handle 11 relative thereto, an operating cassette 12 releasably engageable with the furniture housing portion 10. The cassette 12 of the illustrated embodiment includes a spring housing 13, and a spring housing cover 14, together defining a housing to contain a lever spring 15 and a drive plate 16. The drive plate 16 engages with an elongate spindle 17 indirectly through the engagement of both components with the lever handle and the spindle is also in engagement with a retractable latch (not shown) such that rotation of the handle 11 causes movement of the retractable latch. In use, the handing of the lever door handle will be able to be changed quickly and easily by loosening the operating cassette 12 relative to the furniture housing portion 10 and reorienting the lever handle relative to the operating cassette 12 and the furniture housing portion 10 to change the handedness of the door furniture.

The assembly also includes a snap fit mounting assembly including a first furniture housing portion to be mounted on a first side of the door, a second furniture housing portion to be mounted on a second side of the door, at least one of the first furniture housing portion and second furniture housing portion mounting an opening mechanism and at least one of the first furniture housing portion and second housing portion having a seating groove at least partially about a circumferential surface thereof, at least a pair of connectors associated with one of the first furniture housing portion and second furniture housing portion, each connector being length adjustable and each including at least one abutment shoulder and at least one resilient clip seated in the seating groove and deformable to engage with the at least one abutment surface of each of the connectors when the first furniture housing portion and second furniture housing portion are forced together from opposite sides of the door in order to mount the housing portions to each other.

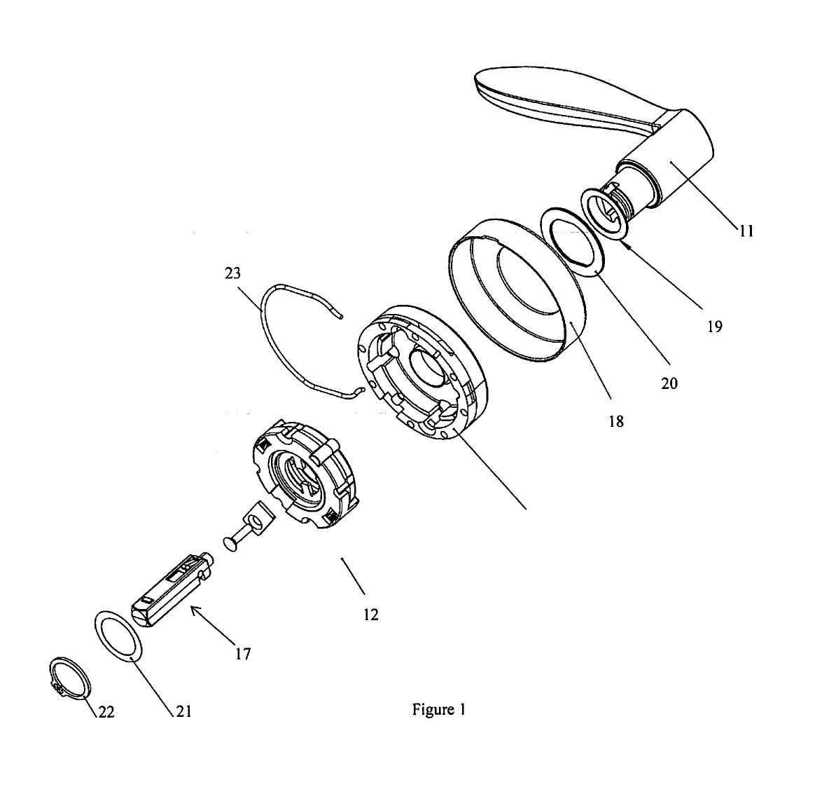

The rotatable door handle 11 is normally mounted relative to the door using an escutcheon or rose mounting the rotatable door handle 11. The escutcheon or rose typically has multiple components in particular, will normally include the furniture housing 10 in order to mount the rotatable door handle 11 relative to the door and a detachable cover or trim 18 which covers the furniture housing portion to provide an aesthetically pleasing view. The assembly illustrated in FIG. 1 also includes a lever washer 19, a trim internal ring 20, a shim 21 and a circlip 22 to mount the handle to the furniture housing 10 and the cassette 12. A spring clip 23 provided as a component of the quick fix attachment system is shown detached from the furniture housing 10.

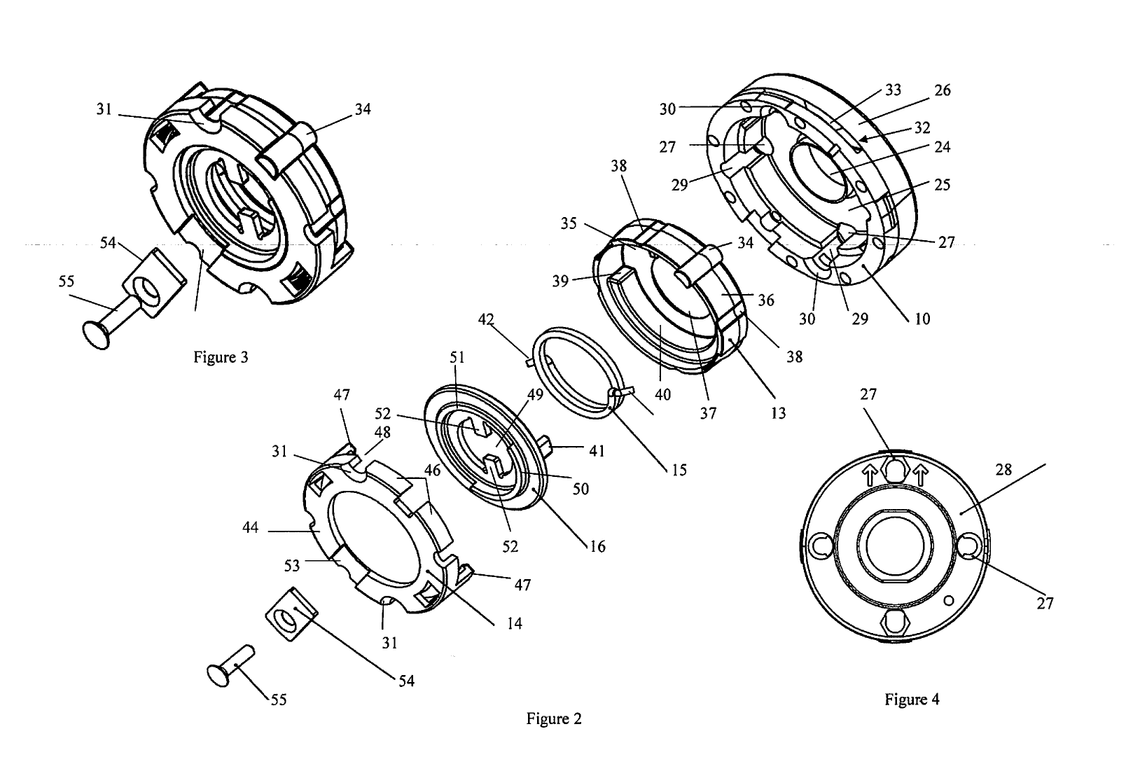

Generally, the housing portion is mounted relative to a door surface. Normally, the housing portion will define a cavity on one side thereof, better seen in FIG. 2. The cavity may be any shape to correspond to the shape of the cassette 12 but is generally circular as illustrated. A central bore 24 is typically provided through the housing portion 10 through which a portion of the door handle 11 is received.

The furniture housing portion 10 has an annular outer wall 25 surrounding the central bore 24 with a peripheral wall 26 extending from an outer edge of the outer wall 25 to define the cavity to receive the cassette 12 on one side thereof. The cavity of the furniture housing portion 10 will preferably receive the cassette 12 therein allowing the portion of the door handle 11 extending through the central bore 24, to engage with the operating components of the cassette 12.

A number of mounting openings 27 are provided, normally through the annular outer wall 25 in order to receive fixing or mounting screws or similar to mount the housing portion 10 relative to the door surface. As best illustrated in FIG. 4, four mounting openings 27 are provided, two mounting openings allowing vertical screw fixing and two mounting openings allowing horizontal screw fixing. Normally, the selection of the mounting openings or combination of mounting openings to be used to mount the assembled furniture 28 will be set at manufacture.

A fastener seating depression 29 is provided on an interior side surface of the peripheral wall 26 corresponding to the location of each of the mounting openings 27 in the furniture housing portion 10 in order to seat the fasteners used to mount the housing portion 10 relative to the door surface at least partially therein. The depressions 29 are arcuate and a semicircular shape is preferred. The mounting openings 27 also have a partially tapered entryway 30 provided about the end of each fastener seating depression 29 located on a free end of the peripheral wall 26. The partially tapered entryway 30 will typically correspond to a partially tapered entryway 31 provided on the cassette 12 to define a tapered entryway, discussed further below.

In relation to the fixing or mounting screws used to mount the housing portion relative to the door surface, it is preferred that at least some of the fixing or mounting screws are quick fix connectors as discussed below

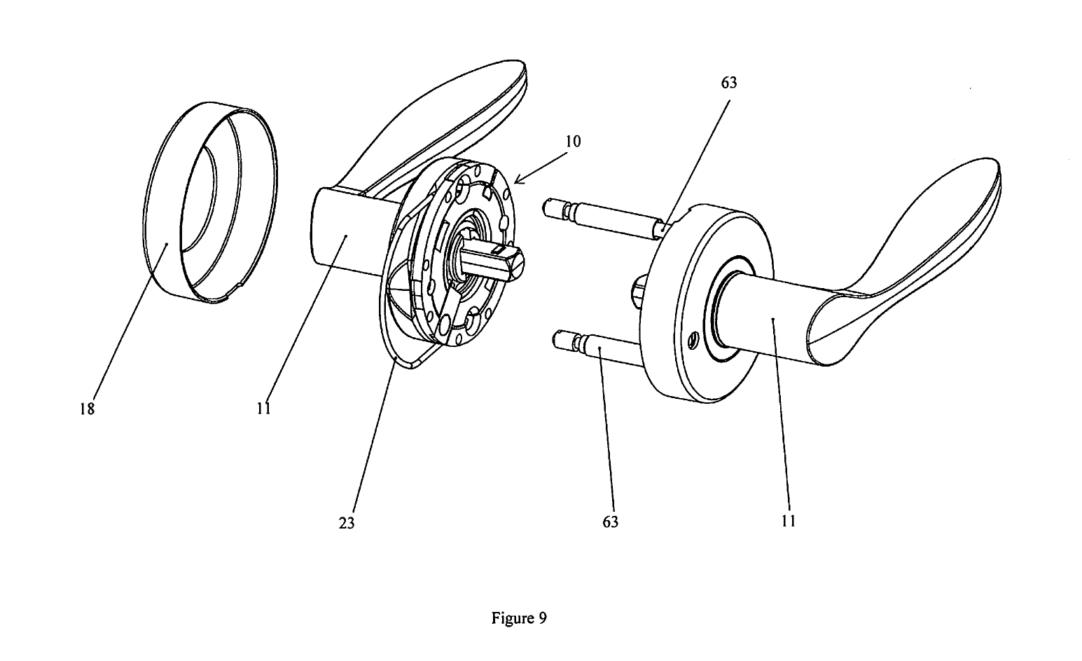

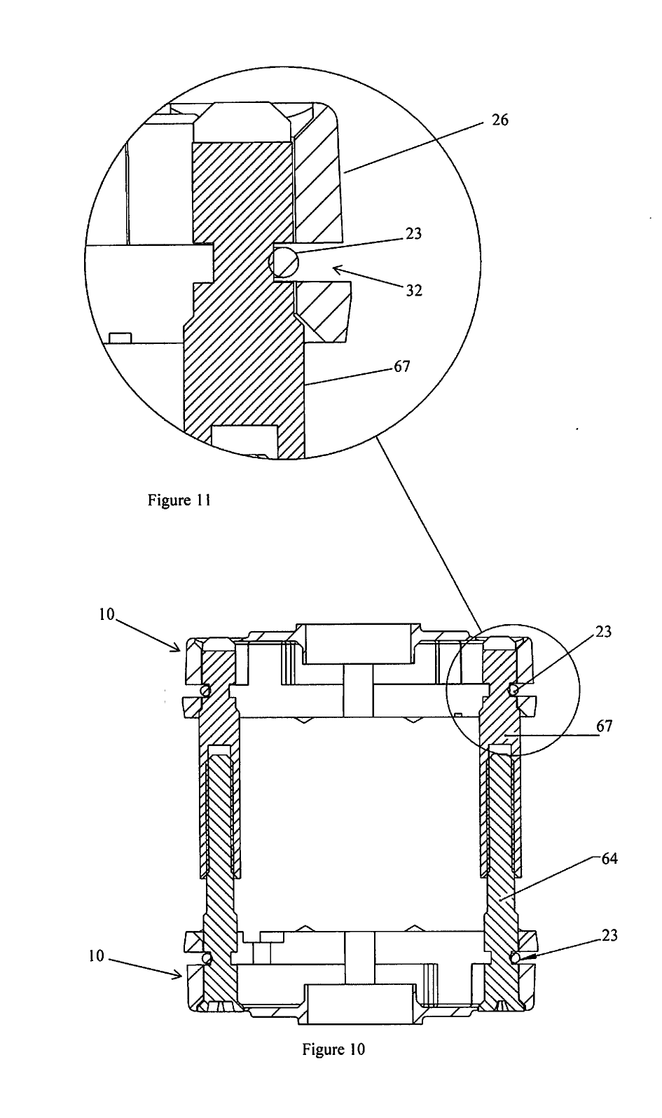

The peripheral wall 26 of the furniture housing portion 10 is also provided with a seating groove 32 into which the spring clip 23 can be at least partially received. The seating groove 32 is provided into the external circular surface of the peripheral wall 26. Some portions of the seating groove 32 may extend deeper into or even completely through the peripheral wall 26 and therefore form elongate slot openings 33 extending through the peripheral wall 26. The seating groove 32 seats the spring clip 23 such that the spring clip 23 extends laterally, partially into the fastener seating depressions 29 in the furniture housing 10 as best illustrated in FIGS. 10 and 11. In this way, the spring clip 23 can engage with portions of the preferred fasteners (as illustrated in FIG. 12) used. As will be discussed below, the spring clip 23 is substantially C-shaped and therefore, the seating groove 32 is also be substantially C-shaped relative to the circular surface of the peripheral wall 26.

It is also further preferred that an internal surface of the peripheral wall 26 is provided with at least one cassette guide or alignment groove or protrusion in order to seat the cassette 12 within the cavity and to prevent rotation of the cassette 12 relative to the furniture housing portion 10 once properly located in the cavity. It is particularly preferred that at least two cassette guide or alignment grooves or protrusions are provided with a corresponding configuration provided on the cassette 12. In a particularly preferred embodiment, a pair of arcuate open grooves is provided to correspond to a pair of arcuate protrusions 34 provided on the cassette.

In use as illustrated in FIG. 9, a matched pair of housing portions 10 is provided, one for either side surface of the door. The matched pair of housing portions 10 are typically provided on either side surface of the door in alignment with one another and then connected together through the door, sandwiching the door between the connected housing portions 10.

The cassette 12 will preferably be provided in an assembled form as illustrated in FIG. 3 in order to minimise the number of parts required to fit the door handle relative to the door. In the preferred embodiment, the spring housing 13 and the spring housing cover 14 clip or snap together.

The illustrated spring housing 13 includes an annular, substantially planar, outer wall 35 and a peripheral wall 36 extending therefrom in order to define a cavity within the spring housing 13. The spring housing 13 includes a substantially centrally located opening 37 in the annular outer wall 35 in order to align with the central bore 24 in the furniture housing portion 10 in order to receive and allow passage to part of the handle 11 and/or spindle 17.

The exterior of the peripheral wall 36 of the spring housing 13 is provided with at least one cassette guide protrusion 34 in order to seat the cassette 12 within the cavity defined in the furniture housing portion 10. Normally, the protrusions 34 are received in the cassette guide grooves provided on an interior surface of the peripheral wall 26 of the furniture housing portion 10. The protrusions are preferably arcuate, preferably extending beyond a free end edge of the peripheral wall 36 in order to guide attachment of the spring housing cover 14 relative to the spring housing 13.

It is preferred that an external surface of the peripheral wall 36 of the spring housing 13 will also be provided with one or more depressions 38 to allow passage of or to partially seat, the mounting fasteners used to mount the furniture housing portion 10 relative to the door. Again, the number of depressions 38 will correspond to the number of fasteners used and typically four depressions are provided. It is preferred that the depressions 38 are arcuate and preferably, the depressions extend over the height of the peripheral wall 36 of the spring housing 13.

An internal side of the peripheral wall 36 is preferably provided with one or more abutment shoulders 39 in order to abut parts of the lever spring 15 and/or a drive plate stop 41 provided on the drive plate 16. Typically, a C shaped portion 40 is provided concentrically within the cavity of the spring housing 13, preferably against or as a part of the peripheral wall 26 with an abutment shoulder 39 provided at either end of the C shaped portion 40. Typically the abutment shoulder 39 provided at one end of the C shaped portion 40 will abut one end 42 of the lever spring 15 in order to brace the lever spring 15 against movement and allow the drive plate 16 to be rotated against the spring force of the lever spring 15 and the abutment shoulder 39 at the other end of the C shaped portion 40 will preferably abut the drive plate stop member 41 in the “home” position with the other side of the drive plate stop member 41 abutting the other end 43 of the lever spring 15 in order to bias the drive plate 16 into the “home” position. This mechanism will typically act to return the handle or knob to the home position following use.

The lever spring 15 of the preferred embodiment is helical, typically circular in shape with an abutment tab 42,43 extending from either end of the lever spring 15 in order to abut other components of the mechanism as described above.

The spring housing cover 14 engages with the spring housing 13 to form the cassette 12 and contain rotating elements of the operating mechanism within. The spring housing cover 14 will typically have an annular, substantially planar wall 44 with a central opening 45 and a number of peripheral side wall portions 46 extending from the annular wall 44 at an outer edge.

One or more snap arms 47 provided with an abutment shoulder are provided on the spring housing cover 14 in order to engage with an outer portion of the annular wall 35 of the spring housing 13 and/or peripheral wall 36 of the spring housing 13 in order to attach the spring housing cover 14 to the spring housing 13 to form the cassette 12. The snap arms 47 are slightly resilient in order to allow the snap arms 47 to be forced over the peripheral wall 36 of the spring housing during attachment. The snap arms 47 typically deform about the connection point of the snap arm 47 with the annular wall 44 of the spring housing cover 14.

The number of peripheral side wall portions 46 are spaced apart in order to allow engagement of the spring housing cover 14 with the spring housing 13. It is preferred that the spring housing cover 14 is also provided with a number of arcuate opening portions 48 to allow passage or seating of the mounting fasteners relative to the spring housing cover 14 and the cassette 12 in general. Again, the arcuate opening portions 48 have a partially tapering entry way 31 in order to define a tapered entry way when the cassette 12 is located relative to the furniture housing portion 10. In use, the tapered entry way of the assembled cassette 12 and furniture housing portion 10 will function to guide a portion of the mounting fasteners and/or quick fix connectors to attach corresponding furniture housing portions to one another on either side of the door.

The drive plate 16 of the preferred embodiment is circular and generally planar. The drive plate 16 has a substantially central opening 49. A drive plate stop member 41 will typically extend substantially perpendicularly from the drive plate 16.

An abutment arc portion 50 may be provided on an opposite side of the drive plate 16 to the drive plate stop member 41. The abutment arc portion 50 will typically have a pair of abutment shoulders, one at either end. Normally the abutment arc portion 50 will stand proud of the drive plate surface. In a particularly preferred embodiment, the abutment arc portion 50 will extend further away from a circular guide ridge 51 provided on the drive plate 16, surrounding the central opening 49.

The drive plate 16 of the preferred embodiment fits within the spring housing 13. In a preferred embodiment, the drive plate 16, and typically the surface of the drive plate 16 on the side having the drive plate stop member 41 will rest and rotate on the preferred C shaped portion 40 provided within the spring housing 13.

The central opening 49 of the drive plate 16 has an opposed pair of engagement tabs 52 extending from the periphery defining the central opening 49 of the drive plate 16 into the central opening 49. Each of the engagement tabs 52 is preferably generally rectangular and extends in the same plane as the drive plate. The engagement tabs 52 will typically engage a portion of the handle which extends into the cassette 12 of the preferred embodiment.

The annular wall 44 of the spring housing cover 14 has a depression 53 therein to receive a stop plate 54 in order to hold the cassette 12 into the cavity of the furniture housing portion 10. In preferred configurations, the stop plate 54 is a generally planar plate. Although the stop plate 54 can have any shape, it is preferred that the stop plate is rectangular. It is also preferred that the stop plate 54 is received in the depression 53 provided to be flush with the surface of the spring housing cover 14. A fastener 55 is typically provided engaging with a portion of the peripheral wall 26 of the furniture housing portion 10 in order to hold the stop plate 54 to the furniture housing portion 10 clamping the cassette 12 within the cavity of the furniture housing portion 10. In use and as illustrated in FIGS. 13A to 13C, the stop plate 54 is loosened (FIG. 13A) and the lever handle 11 rotated relative to the cassette 12 normally through 180° (FIG. 13B) and re-engaged, then the stop plate 54 is re-tightened (FIG. 13C). The cassette 12 normally stays substantially in place, and due to the reversal of orientation of the lever handle relative to the cassette 12, the lever handle engages the internal components of the cassette 12 in the opposite direction.

The assembly also includes a hold-in spindle system including an elongate spindle 17, a spindle retaining member 56 engageable with the spindle 17 and having a pair of deformable arms 57 with a portion extending laterally beyond the spindle in order to releasably engage the spindle 17 with a furniture housing portion 10 and at least one rigid engagement portion or spindle mounting pin 58 to engage with the spindle 17 such that the elongate spindle 17 and spindle retaining member 56 can be snapfit to the level handle 11 as illustrated in FIG. 9 to be held there by tabs 52 on the drive plate 16.

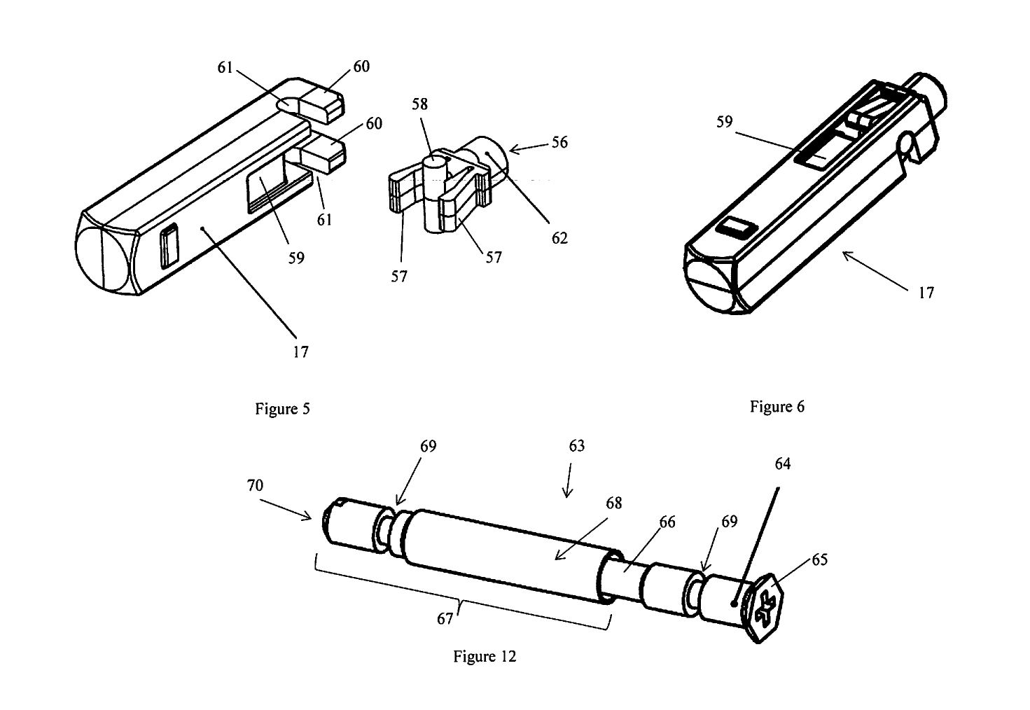

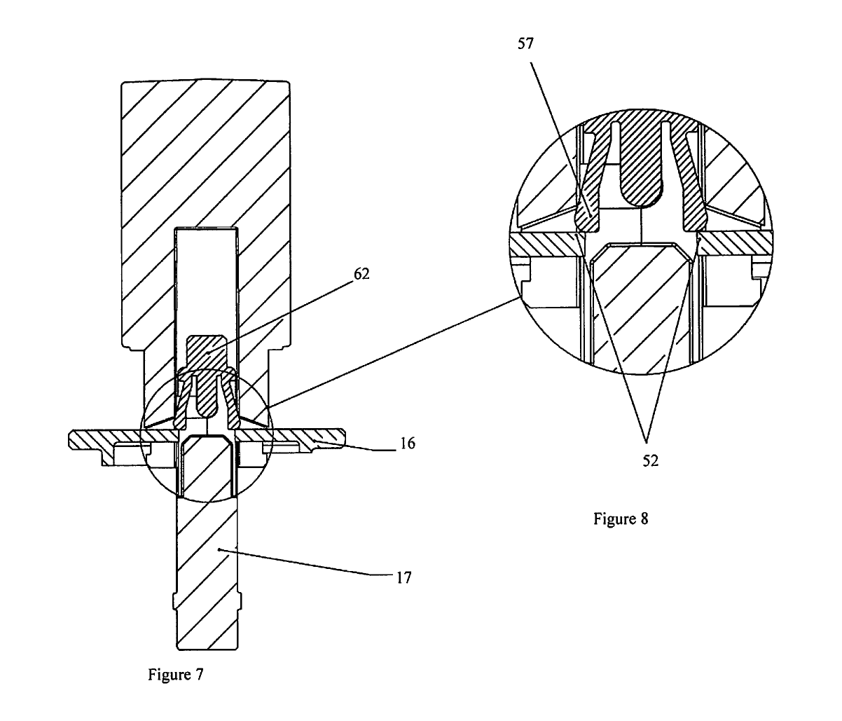

The spindle illustrated in FIGS. 5 and 6 can be snapfit relative to the operating components of the mechanism providing tactile and/or audible feedback as to the engagement of the spindle with the operating components of the mechanism and which will prevent the spindle being accidentally disconnected during assembly and disassembly.

As illustrated, the spindle 17 is typically elongate and generally rectangular. A depression 59 is provided in a pair of opposed side walls of the spindle 17 in order to receive the engagement tabs 52 provided on the drive plate 16.

The hold-in spindle illustrated has a divided tail to be received at least partially within the cassette 12. The divided tail is configured as a pair of spaced apart portions 60 to receive a part of a spindle retaining member 56 therebetween. A laterally extending opening 61 is provided in each of the spaced apart portions 60 in order to receive a spindle mounting pin 58 thereinto. Normally, the laterally extending openings 61 are provided in or into sidewalls other than the sidewalls with the depression 59 to receive the engagement tabs 52. The laterally extending openings 61 are preferably substantially U-shaped and allow insertion and removal of the spindle mounting pins 58 in order to assemble and remove the spindle retaining member 56 from the spindle 17.

The spindle retaining member 56 will typically have a body 62 from which the spindle mounting pins 58 extend.

The spindle retaining member 56 has a pair of deformable arms 57 with a free end of each arm extending laterally beyond the spindle 17 in order to engage the spindle 17 with the engagement tabs 52 on the drive plate 16. Typically, the spindle mounting pin 58 and the deformable arms 57 extend substantially perpendicularly to one another.

The deformable arms 57 extend from the body of the spindle retaining member 56. When the spindle retaining member 56 is assembled with the spindle 17, the deformable arms 57 are positioned such that they can be deformed inwardly to sit within the depressions 59 provided for the engagement tabs 52. The free end of each deformable arm 57 will typically stand proud of the spindle surface unless deformed. The free end of the deformable arms 57 allows the engagement tabs 52 to pass (through deformation of the deformable arms 57) and then the resilience of the deformable arms 57 will typically return them to stand proud of the spindle 17 in order to engage with a side surface of the engagement tabs 52 to hold the spindle 17 to the drive plate 16. The deformable arms 57 will typically diverge away from the body of the spindle retaining member 56.

The configuration of the spindle and the spindle retaining member means that the spindle can be removed and replaced if needed. However, if sufficient force is applied to the spindle 17 to remove the spindle 17 from the drive plate 16, the deformable arms 57 may collapse in order to allow removal of the spindle 17. Removal in this way may ruin in the spindle retaining member 56 requiring a new spindle retaining member 56 to be assembled prior to attaching the spindle 17 with the assembly. Preferably, a user will be able to remove and re-insert the spindle without ruining the spindle retaining member.

It is preferred that the spindle retaining member 57 is manufactured from plastic in order to provide rigidity to the spindle mounting pins and also provide the deformable arms with resilience.

As mentioned above, the spring clip 23 of preferred embodiments will normally be substantially C-shaped. The spring clip 23 will normally be manufactured of metal. The spring clip 23 will normally be provided with a pair of free ends and the free ends will normally converge toward one another to allow the spring clip to engage the furniture housing portion 10.

The spring clip of a preferred embodiment will have a substantially circular cross-section. The preferred cross sectional shape will allow the spring clip 23 to be forced into deformation in order to allow the preferred quick fix connectors to pass through the provision of an angled or tapered surface on the quick fix connectors but once seated in the seating groove 32, and engaging the abutment shoulders provided on the quick fix connectors, the spring clip will typically prevent withdrawal of the quick fix connectors unless the spring clip 23 is again deformed to allow the release of the quick fix connectors. The seating groove 32 will typically allow the spring clip 23 to be received below the level of the peripheral wall of the furniture housing portion 10.

One or more quick fix connectors 63 as illustrated in FIG. 12 are preferably provided in order to attach corresponding furniture housing portions 10 relative to one another on opposite sides of the door as illustrated in FIG. 9. Each quick fix connector 63 will typically be elongate and have two parts namely a fastener portion 64 having an enlarged head 65 and an external thread provided on a shank 66 and a connector barrel 67 which is typically internally threaded in order to engage with the external thread provided on the shank 66 of the fastener portion 64.

Normally, the enlarged head 65 of the fastener portion 64 will have an engagement configuration adapted to engage with a tool to allow the fastener to be rotated, which in FIG. 12, is a Philips head shape.

The connector barrel 67 is preferably provided with a hollow, tubular part 68 with a circumferentially extending groove 69 provided towards an outer end 70 of the connector barrel 63 defining a pair of spaced apart abutment shoulders against which the spring clip 23 can abut. The outer end 70 will normally be closed and the outer end 70 is tapered or angled in order to force deformation of the spring clip 23.

The shank 66 of the fastener portion 64 is also provided with a circumferentially extending groove 69 provided towards the head 65 of the fastener portion 64 but spaced therefrom defining a pair of spaced apart abutment shoulders against which the spring clip 23 can abut.

As illustrated in FIGS. 11 and 12, in use, the circumferentially extending grooves 69 on the quick fix connectors 63 will engage with a spring clip 23 provided on each furniture housing portion 10 to hold the quick fix connector 63 relative thereto. In use, the head 65 of the quick fix connector 63 is typically attached to one furniture housing portion 10 using the spring clip 23 and the outer ends 70 of the quick fix connectors 63 can then be inserted into the mounting openings 27 of a corresponding furniture housing portion 10 on the opposite side of the door. Pushing the housing portions 20 together forces the outer end 70 of the connector barrel 67 to temporarily deform the spring clip 23 allowing passage of the connector barrel 67 and the spring clip 23 will resiliently returned to seat in the seating groove 32 of the furniture housing portion 10 and the circumferentially extending groove 69 on the quick fix fastener 63, attaching the housing portions 10 together either side of the door. The connector barrel 67 can then be rotated to clamp the housing portions 10 together on either side of the door.

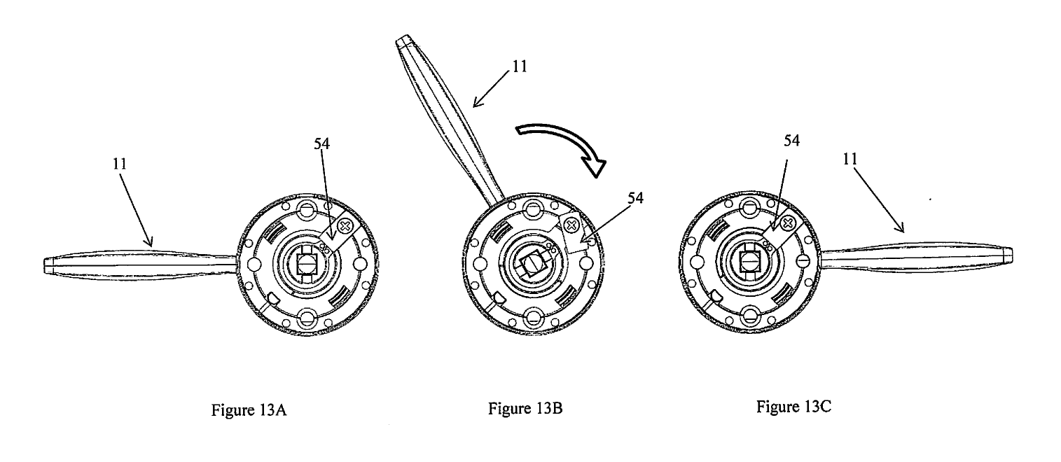

In an alternative embodiment illustrated in FIGS. 14A to 17, the fastener portion 81 of each quick fix connector 63 has an enlarged head 83 and an external thread provided on a shank. In this alternative embodiment, the enlarged head 83 is hex-shaped to engage with a correspondingly hex-shaped depression 84 provided about the mounting opening 85 provided in the cassette and/or assembled furniture.

In this embodiment, the mounting openings 85 are arcuate and as illustrated in FIG. 16, a pair of substantially opposed arcuate mounting openings 85 is provided, one for each of the pair of quick fix connectors 63. The hex-shaped depression 84 is provided partially about one end of the arcuate mounting openings 85 as shown in the detail on FIG. 16. The arcuate mounting openings 85 engage the enlarged head 83 of the fastener portion of the quick fix connector 63 in a bayonet fitting such that the enlarged head 83 can be inserted into one end of the arcuate mounting opening 85 which allows passage of the enlarged head 83 and the quick fix connector can then be moved relative to the arcuate mounting opening 85 to hold the quick fix connector 63 in the arcuate mounting opening 85 with the shaped enlarged head 83 received at least partially in the correspondingly shaped depression 84 provided. The engagement of the shaped enlarged head 83 and depression 84 also means that the quick fix connector 63 can be tightened by rotation of the connector barrel portion 82 without rotation of the fastener portion 81 of the quick fix connector 63.

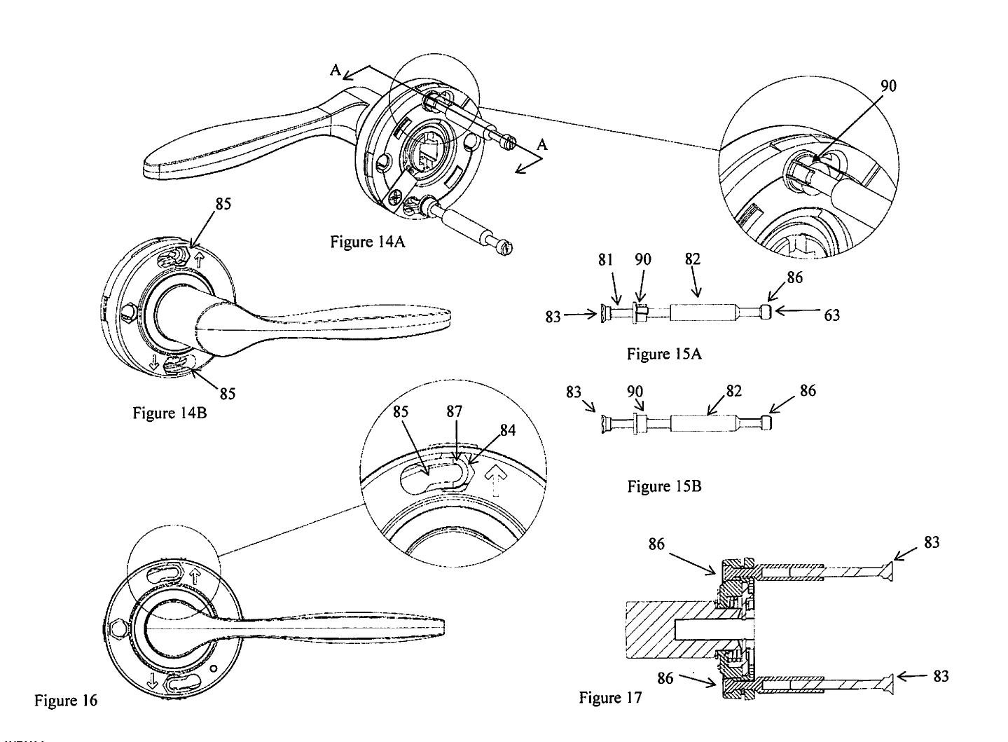

As illustrated in FIG. 15A and the detail of FIG. 14A, the shank of the fastener portion 81 is also provided with a circumferential abutment shoulder, normally towards the head 83 of the fastener portion 81 but spaced therefrom. In the preferred form illustrated, the at least one circumferential abutment shoulder is provided on an alignment nut 90 mounted for movement along the externally threaded shank of the fastener portion 81.

The alignment nut 90 has an internally threaded bore such that the alignment nut 90 can be wound along the shank of the fastener portion 81 to abut one side of the cassette and/or assembly furniture to hold the enlarged head 83 of the fastener portion 81 in the correspondingly shaped depression 84 to hold the quick fix connectors 63 relative to the cassette and/or assembly furniture as well as to align the quick fix connectors 63 substantially perpendicularly to the cassette and/or assembly furniture.

In this configuration, the connector barrel portion 82 is also provided with an enlarged head 86 which can be used to engage the cassette and/or assembled furniture arrangement on an opposite side of the door as illustrated in FIG. 17 to the cassette and/or assembled furniture arrangement to which the fastener portion 81 of the quick fix connectors 63 is mounted. The enlarged head 86 of the connector barrel portion 82 engages with a shaped depression provided about the mounting opening, preferably allowing rotation of the connector barrel portion 82 whilst engaged.

The shaped depression provided in the cassette and/or assembled furniture arrangement may therefore have a substantially circular depression portion 87 surrounded by a hex shaped depression portion 84 allowing the enlarged head of each of the fastener portion 81 or the connector barrel portion 82 to be engaged, as required. This will preferably allow rotation of the connector barrel portion 82 whilst engaged but prevent rotation of the fastener portion 81 whilst engaged.

In use, the enlarged head 83 of the fastener portion 81 on the quick fix connectors 63 will engage with the substantially circular depression portion 87 provided on each furniture housing portion to hold the quick fix connector 63 relative thereto. In use, the quick fix connectors 63 are set at an approximate length for use, typically attached to one furniture housing portion by the connector barrel portion 82. The enlarged head 83 of the fastener portion 81 can then be inserted into the mounting openings 85 of a corresponding furniture housing portion on the opposite side of the door. Rotation of the housing portions on either side of the door will preferably move the enlarged head 83 of the fastener portion 81 into the hex shaped depression portion 84, attaching the housing portions together either side of the door. The alignment nut 90 is then wound to abut the cassette and/or furniture assembly as shown in the detail of FIG. 14A. The housing portions can then be assembled onto the door and attached to a matching housing portion. The connector barrel portion 82 can then be rotated to tighten the connection in order to clamp the housing portions together on either side of the door.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A door furniture assembly for a rotatable door handle or lever, the door furniture assembly comprising:
a rotatable door handle or lever;
at least one furniture housing portion adapted to mount the rotatable door handle or lever relative thereto,
an operating cassette releasably engageable with the at least one furniture housing portion, the operating cassette including a spring housing, and a spring housing cover, together defining a housing to contain a lever spring and a drive plate to engage with the rotatable door handle or lever; and
an elongate spindle to engage with the rotatable door handle or lever and a retractable latch such that rotation of the door handle or lever causes movement of the retractable latch wherein the rotatable door handle or lever can be reoriented relative to the operating cassette to change the handedness of the door furniture assembly.

2. The door furniture assembly as claimed in claim 1 wherein the at least one furniture housing portion has an annular outer wall surrounding a central bore with a peripheral wall extending from the annular outer wall to define a cavity on one side thereof to receive the operating cassette therein allowing a portion of the rotatable door handle or lever extending through the central bore, to engage with the operating cassette.

3. The door furniture assembly as claimed in claim 1 wherein a number of mounting openings are provided through an annular outer wall in order to receive fixing or mounting fasteners to mount the at least one furniture housing portion relative to a door surface allowing both vertical screw fixing and horizontal screw fixing.

4. The door furniture assembly as claimed in claim 2 wherein the peripheral wall of the at least one furniture housing portion is provided with a seating groove into which a spring clip can be at least partially received.

5. The door furniture assembly as claimed in claim 1 wherein the spring housing and the spring housing cover clip or snap together.

6. The door furniture assembly as claimed in claim 1 wherein the operating cassette is provided with at least one engagement portion and a corresponding portion is provided on the at least one furniture housing portion in order to seat the operating cassette relative to the at least one furniture housing portion and to prevent rotation of the operating cassette relative to the furniture housing portion once properly fitted.

7. The door furniture assembly as claimed in claim 1 wherein the drive plate has a central opening with an opposed pair of engagement tabs extending from a periphery defining the central opening of the drive plate into the central opening and extending in the same plane as the drive plate to engage a portion of the rotatable door handle or lever which extends into the operating cassette.

8. The door furniture assembly as claimed in claim 1 wherein the operating cassette has at least one depression therein to receive a stop plate in order to releasably hold the operating cassette relative to the at least one furniture housing portion and wherein the stop plate must be at least loosened to free the operating cassette from the at least one furniture housing portion to allow the rotatable door handle or lever to be moved to change handing.

9. A hold-in spindle system for a rotatable door handle or lever mechanism, the system comprising:
an elongate spindle,
at least one furniture housing portion mounting a handle or lever for rotation against a resilient return,
a spindle retaining member engageable with the elongate spindle and having at least one deformable arm with a portion extending laterally beyond the elongate spindle in order to releasably engage the elongate spindle with the at least one furniture housing portion and at least one rigid engagement portion to engage with the elongate spindle such that the elongate spindle and spindle retaining member can be snapfit to the at least one furniture housing portion to be held there by the spindle retaining member.

10. The hold-in spindle system as claimed in claim 9 further including at least one door furniture housing portion having a drive member associated therewith having a central opening with an opposed pair of engagement tabs extending from a periphery defining the central opening of the drive plate into the central opening and extending in the same plane as the drive plate to engage the elongate spindle.

11. The hold-in spindle system as claimed in claim 10 wherein the elongate spindle has a depression provided in a pair of opposed side walls of the elongate spindle in order to receive the opposed pair of engagement tabs provided on the drive plate.

12. The hold-in spindle system as claimed in claim 10 wherein the elongate spindle has a divided tail having a pair of spaced apart portions to be received between the opposed pair of engagement tabs, and to receive a part of the spindle retaining member therebetween, each of the spaced apart portions having a laterally extending opening in order to receive the at least one rigid engagement portion thereinto.

13. The hold-in spindle system as claimed in claim 9 wherein the spindle retaining member includes a pair of opposed deformable arms.

14. The hold-in spindle system as claimed in claim 13 wherein the elongate spindle has a depression provided in a pair of opposed side walls of the spindle in order to receive the engagement tabs provided on a drive plate and wherein when the spindle retaining member is assembled with the elongate spindle, the pair of opposed deformable arms are positioned such that they can be deformed inwardly to sit within depressions provided for engagement tabs with a free end of each deformable arm standing proud of a spindle surface unless deformed.

15. A snap fit mounting assembly for door furniture, the snap fit mounting assembly comprising:
a first furniture housing portion to be mounted on a first side of a door, a second furniture housing portion to be mounted on a second side of the door, at least one of the first furniture housing portion and second furniture housing portion engageable with an opening mechanism and at least one of the first furniture housing portion and second housing portion having a seating groove at least partially about a circumferential surface thereof, at least a pair of connectors associated with one of the first furniture housing portion and second furniture housing portion, each connector being length adjustable and each including at least one abutment shoulder and at least one resilient clip seated in the seating groove and deformable to engage with the at least one abutment shoulder of each of the connectors when the first furniture housing portion and second furniture housing portion are forced together from opposite sides of the door in order to mount the first and second furniture housing portions to each other.

16. The snap fit mounting assembly as claimed in claim 15 wherein each connector has at least a fastener portion having an enlarged head and an external thread provided on a shank and a connector barrel portion including a barrel which is internally threaded in order to engage with the external thread provided on the shank of the fastener portion.

17. The snap fit mounting assembly as claimed in claim 16 wherein at least one circumferentially extending groove is provided towards an outer end of the connector barrel portion defining a pair of spaced apart abutment shoulders against which the at least one resilient clip can abut.

18. The snap fit mounting assembly as claimed in claim 16 wherein an outer end of the connector barrel portion is tapered in order to force deformation of the at least one resilient clip as the connector barrel portion abuts the at least one resilient clip.

19. The snap fit mounting assembly as claimed in claim 16 wherein at least one circumferentially extending groove is provided towards the enlarged head of the fastener portion but spaced therefrom defining a pair of spaced apart abutment shoulders against which the at least one resilient clip abuts.

20. The snap fit mounting assembly as claimed in claim 15 wherein the at least a pair of connectors are set at an approximate length for use and attached to the first furniture housing portion using the at least one resilient clip, aligned with the second furniture housing portion on an opposite side of the door with the connectors extending through the door and the first furniture housing portion pushed toward the second furniture housing portion which forces deformation of the at least one resilient clip to allow a portion of the connectors to pass until the at least one resilient clip abuts the abutment shoulder to hold the respective first and second furniture housing portions to one another.

21. A mounting assembly for door furniture, the mounting assembly comprising:
a first furniture housing portion to be mounted on a first side of a door, a second furniture housing portion to be mounted on a second side of the door, at least one of the first furniture housing portion and second furniture housing portion engageable with an opening mechanism;
at least one of the first furniture housing portion and second furniture housing portion having at least a pair of arcuate openings therein, each arcuate opening having a shaped portion and at least one bayonet wall provided therein; and
at least a pair of connectors associated with one of the first furniture housing portion and second furniture housing portion and removeably detachable from the other of the first furniture housing portion and second furniture housing portion, each connector being length adjustable and each including at least one enlarged shaped head such that the enlarged head of each of the connectors is insertable into one of the arcuate openings and upon relative rotation of the first furniture housing portion and second furniture housing portion, the enlarged head passes into in a bayonet fitting into the shaped portion to be held preventing rotation of the enlarged head.
